(19) United States
(12) Patent Application Publication
(10) Pub. No.: US 2007/0139915 A1
(43) Pub. Date: Jun. 21, 2007

(54) Housing sealing arrangement

(76) Inventor: Trent Edward Walters, Tipp City, OH (US)

Correspondence Address: DINSMORE & SHOHL LLP;One Dayton Centre, Suite 1300, One South Main Street, Dayton, OH, 45402-2023, US

(21) Appl. No.: 11/216,745

(22) Filed: Aug. 31, 2005

(51) Int. Cl. F21L 4/00

(52) U.S. Cl. 362/158

(57) ABSTRACT

A casing for a portable, battery-powered device has a battery compartment for receiving one or more batteries. The casing includes a case defining the battery compartment, and an opening to permit access to the battery compartment. A door is pivotally attached to the case and is manually pivotable from a closed position in which it covers the opening, to an open position permitting access to the battery compartment. An overmolded layer is molded over at least a portion of the exterior surface of the case. The overmolded layer surrounding the opening, and provides sealing of said battery compartment opening in conjunction with said door.

Not applicable.

### STATEMENT REGARDING FEDERALLY SPONSORED RESEARCH OR DEVELOPMENT

Not applicable.

### BACKGROUND OF THE INVENTION

The present invention relates to a casing or housing for a portable device. More particularly, the invention deals with a casing or housing for a battery powered device that has an internal compartment and an opening that provides access into the compartment. Typically, a cover or door is latched into place to cover the compartment opening, except when access to the compartment is desired.

There are a wide variety of devices of this type which, because of their portable nature, may be exposed to harsh conditions, such as for example, heat, humidity, and moisture. The electrical components of these devices are particularly susceptible to deterioration, including rust and other corrosion. One part of such devices that is particularly sensitive to the deleterious effects of moisture and humidity is the battery compartment. The battery contacts are typically simple spring contacts, which press against the terminals of the batteries as the batteries are inserted into the battery compartment. If the battery compartment is not sealed, moisture and humid air can enter the compartment, and over time can cause corrosion and oxidation of the contacts, resulting in a deterioration of the quality of the electrical contact.

Many devices of this type have battery compartments that are sealed to prevent the entry of moisture. Typically, an O-ring surrounds the opening of the battery compartment. and cooperates with a door or cover that is secured over the opening to seal the batteries and associated contacts from the environment. The O-ring is made of an elastomer, which compresses between the case and the cover to effect a moisture seal. While this works quite well, it will be appreciated that the O-ring must be secured in position in some manner so that it does not separate from the casing when the battery compartment door is opened. Typically the O-ring is seated in a shallow groove surrounding the opening to the battery compartment, and maintained in that position by an adhesive. It will be appreciated that handling such thin O-rings can be difficult, and insuring that a sufficient amount of properly positioned adhesive is in place is even more difficult. If too much adhesive is used, it can interfere with sealing, while if not enough adhesive is used, it can result in the O-ring coming loose and being lost.

It is seen, therefore, that there is a need for a casing that provides a sealed battery compartment, but which does not include a separate O-ring that must be held in place with adhesive.

### SUMMARY OF THE INVENTION

This need is met by a casing or housing constructed according to the present invention for a portable device having an internal compartment. The casing has a case with an internal compartment, and an opening in the case to permit access to the compartment. The casing further includes a cover, mountable on the case, and manually removable so that the compartment may be accessed. The cover may be a door that is pivotally attached to the case. The door may be manually pivoted from a closed position, in which it covers the opening, to an open position in which the battery compartment is accessible. An overmolded layer is molded over at least a portion of the exterior surface of the case. The overmolded layer surrounds the opening, providing sealing of the opening in conjunction with the cover.

A latch mechanism latches the cover in a closed position. The case defines a groove surrounding the opening. The overmolded layer includes material molded into the groove to act as an O-ring. The casing defines a channel extending from the grove outward to an area on the casing carrying the overmolded layer. The overmolded layer comprises a layer of elastomer material. The overmolded layer may include an integral, overmolded O-ring portion, which surrounds the opening and which is compressed when the cover is moved into position to cover the opening. The O-ring portion effectively seals the compartment opening in conjunction with the cover.

It is an object of the present invention to provide a casing for a portable device having a case that defines an internal compartment, a cover for covering the compartment opening and a layer that is overmolded over the case, in which the overmolded layer seals the opening in conjunction with the cover. Other objects and advantages of the invention will be apparent from the following description, the accompanying drawings, and the appended claims.

### BRIEF DESCRIPTION OF THE DRAWINGS

FIG. 1 is a plan view of the casing of a portable, battery-powered device, showing the case, and the battery compartment door;

FIG. 2 is a perspective view of the casing of the present invention, shown with the door in an open position to reveal the battery compartment and the batteries therein; and

FIG. 3 is an exploded perspective view of a portion of the casing with the door and associated elements removed.

### DETAILED DESCRIPTION OF THE PREFERRED EMBODIMENT

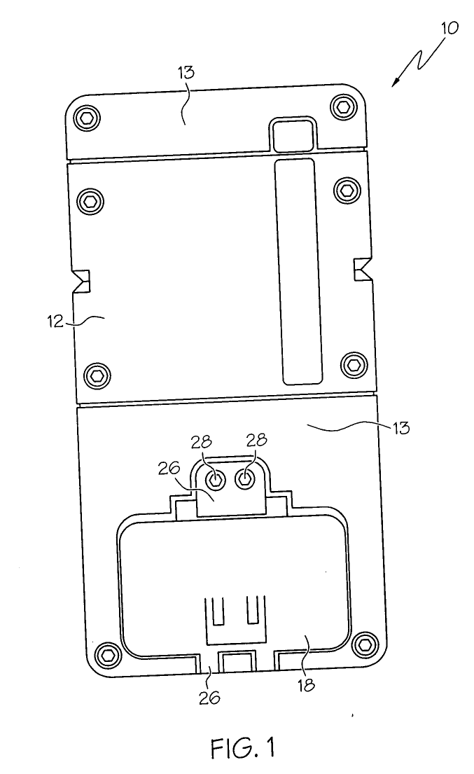

Reference is made to FIGS. 1-3, which illustrate a casing or housing 10, constructed according to the present invention. The casing or housing 10 houses a portable, battery-powered electrical device, such as for example a radio receiver, a GPS receiver, a laser beam receiver, or any of a number of other, similar devices which must be rugged, and capable of withstanding exposure to adverse environmental conditions. The casing 10 has a case 12, which is made of a relatively hard material, such as for example a metal or a hard molded plastic material. The casing 10 further includes an overmolded layer 13 of an elastomer material that is molded over at least a portion of the exterior surface of the case 12. The overmolded layer 13 resists scuffing and abrasion, and is softer than the case 12, providing a cushioning in the event that the device is dropped.

The overmolding process is straightforward. The case 12 is inserted in an injection mold, and a quantity of uncured elastomeric material is injected into the mold. The elastomeric material forms a layer surrounding and engaging at least a portion of the exterior surface of the case 12. The elastomeric material is then cured, and the overmolded part is ejected from the mold. The elastomeric material is softer than the case 12 and acts to cushion the electronic device against impacts to which the casing may be subjected.

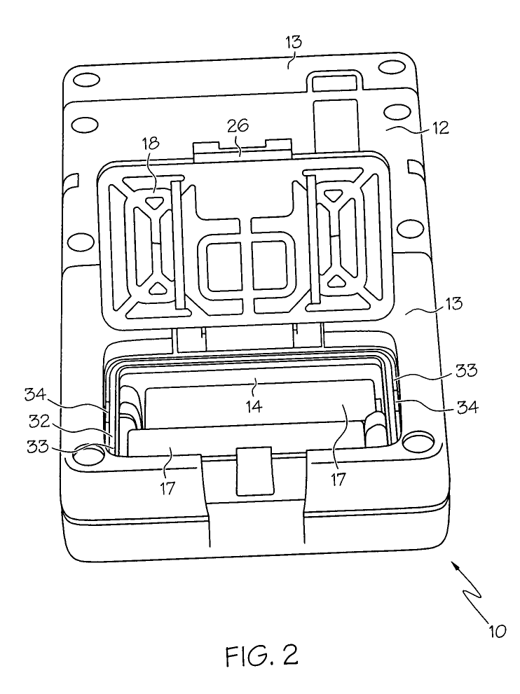

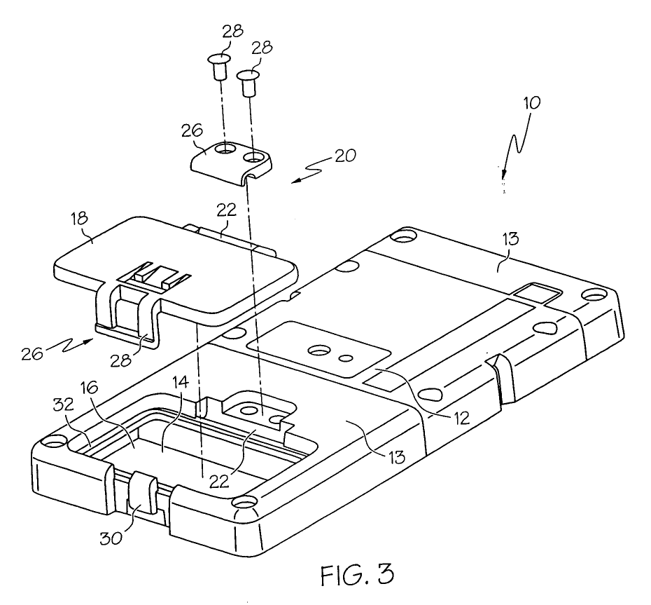

Case 12 has an internal compartment 14, and an opening 16 that provides access to the internal compartment 14. The internal compartment may, for example, be a battery compartment into which batteries 17 are inserted to power the electronic device. A cover or door 18 is mounted on the case 12, and is preferably manually removable so that the compartment can be accessed. As will be noted in FIGS. 2 and 3, the cover 18 has a pivot arrangement 20, including pivot shaft 22, a groove 24 in case 12 that receives pivot shaft 22, and a plate 26 and screws 28 that hold shaft 22 in groove 24. As best seen in FIG. 2, the overmolded layer 13 surrounds the opening 16. The overmolded layer 13 provides sealing of the compartment opening 16 in conjunction with the door 18. The door 18 is pivotally attached to the case 12. The door is manually pivotable from a closed position, shown in FIG. 1, in which it covers the opening, to an open position, shown in FIG. 2, in which access to the internal compartment 14 is provided. It will be appreciated that other door configurations are commonly used in such devices, including doors that slide between open and closed positions. The present invention will find utility with all such door configurations.

As will be noted in FIG. 2, the casing 10 further comprises a latch mechanism 26 for latching the door 18 in the closed position. The latch mechanism 26 includes a spring arm 28 and a latch tab 30. Arm 28 engages latch tab 30 when the door 18 is latched closed.

The case 12 defines a groove 32 that surrounds the opening 16. The overmolded layer 13 includes material that is molded into the groove 32 to provide O-ring 33. The casing defines channels 34 that extend from the grove 24 outward to areas on the casing carrying the overmolded layer 13. These channels 34 provide for a flow of the elastomer material in the mold so that the O-ring 33 can be formed in situ. The integral, overmolded O-ring 33 surrounds the opening 16 and is compressed when the door 18 is pivoted into the closed position. Also, the latch mechanism 26 does not fully engage until the door 18 is pressed into its closed position in which it compresses the O-ring 33. As a result, the O-ring 33 effectively seals the internal compartment opening in conjunction with the door 18. This seal is water and vapor tight, limiting significantly the corrosion of the batteries and battery terminals that would otherwise take place. It will be appreciated that other compartments may be provided in a device of this type. It may also be desirable to seal these compartments against environmental factors.

While certain representative embodiments and details have been shown for purposes of illustrating the invention, it will be apparent to those skilled in the art that various changes in the invention disclosed herein may be made without departing from the scope of the invention, which is defined in the appended claims.

What is claimed is:

1. A casing for a portable, battery-powered device having a battery compartment for receiving a battery, comprising:
a case having a battery compartment therein, defining an opening to permit access to said battery compartment,
a door, pivotally attached to said case, said door being manually pivotable from a closed position in which it covers said opening, to an open position in which access to said battery compartment may be achieved,
an overmolded layer, molded over at least a portion of the exterior surface of said case, said overmolded layer surrounding said opening, whereby said overmolded layer provides sealing of said battery compartment opening in conjunction with said door.

2. The casing of claim 1 in which said casing further comprises a latch mechanism for latching said door in said closed position.

3. The casing of claim 1 in which said case defines a groove surrounding said opening, said overmolded layer including material molded into said groove so as to act as an O-ring.

4. The casing of claim 3, in which said casing defines a channel extending from said grove outward to an area on said casing carrying an overmolded layer.

5. The casing of claim 1 in which said overmolded layer comprises a layer of elastomer material.

6. The casing of claim 1 in which said overmolded layer includes an integral, overmolded O-ring portion which surrounds said opening and which is compressed when said door is pivoted into said closed position, said O-ring portion effectively sealing said battery compartment opening in conjunction with said door.

7. A housing for a device having an internal compartment, comprising:
a case defining an internal compartment and an opening into said internal compartment,
a door, pivotally attached to said case, said door being manually pivotable from a closed position in which it covers said opening, to an open position in which said opening is uncovered and said compartment may be accessed,
an overmolded layer, molded over at least a portion of the exterior surface of said case, said overmolded layer surrounding said opening, whereby said overmolded layer provides sealing of said compartment opening in conjunction with said door.

8. The housing of claim 7 in which said housing further comprises a latch mechanism for latching said door in said closed position.

9. The housing of claim 7 in which said case defines a groove surrounding said opening, said overmolded layer including material molded into said groove so as to act as an O-ring.

10. The housing of claim 9, in which said case defines a channel extending from said grove outward to an area on said case carrying an overmolded layer.

11. The housing of claim 7 in which said overmolded layer comprises a layer of elastomer material.

12. The housing of claim 7 in which said overmolded layer includes an integral, overmolded O-ring portion which surrounds said opening and which is compressed when said door is pivoted into said closed position, said O-ring portion effectively sealing said compartment opening in conjunction with said door.

13. A casing for a portable device having an internal compartment, comprising:
a case having an internal compartment therein, and an opening to permit access to said compartment,
a cover, mountable on said case, said cover being manually removable so that the compartment may be accessed,
an overmolded layer, molded over at least a portion of the exterior surface of said case, said overmolded layer surrounding said opening, whereby said overmolded layer provides sealing of said opening in conjunction with said cover.

14. The casing of claim 13, further comprising a latch mechanism for latching said cover in a closed position.

15. The casing of claim 13 in which said case defines a groove surrounding said opening, and in which said overmolded layer includes material molded into said groove to act as an O-ring.

16. The casing of claim 15, in which said casing defines a channel extending from said grove outward to an area on said casing carrying said overmolded layer.

17. The casing of claim 13 in which said overmolded layer comprises a layer of elastomer material.

18. The casing of claim 13 in which said overmolded layer includes an integral, overmolded O-ring portion which surrounds said opening and which is compressed when said cover is moved into position to cover said opening, said O-ring portion effectively sealing said compartment opening in conjunction with said cover.
